(19) United States
(12) Patent Application Publication
(10) Pub. No.: US 2010/0192636 A1
(43) Pub. Date: Aug. 5, 2010

(54) METHOD OF RECYCLING THE WATER FROM A PROCESS FOR MANUFACTURING AN INSULATING MINERAL FIBER BLANKET

(75) Inventors: Remi Valero, Tassin La Demi Lune (FR); Bernard Lericque, Monchy Saint Eloi (FR); Alexis Ponnouradjou, Massachusetts, MA (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Isover, Courbevoie (FR)

(21) Appl. No.: 12/667,458

(22) PCT Filed: Jul. 2, 2008
(86) PCT No.: PCT/FR2008/051230

§ 371 Date: Apr. 14, 2010

(30) Foreign Application Priority Data
Jul. 4, 2007 (FR) 0756267

(51) Int. Cl. C02F 1/66; C03B 37/00; C03B 37/07

(52) U.S. Cl. 65/503; 210/765; 65/484

(57) ABSTRACT

The invention relates to a method of controlling the level of corrosivity of an aqueous solution recovered during a process for producing a blanket of mineral fibers, comprising in particular the fiberizing and the coating of said fibers with a binder comprising a polyacid typically of the acrylic type, said aqueous solution being at least partly recycled into a zone in which said resin is prepared and/or a scrubbing zone of the production plant, said method being characterized in that the pH of the solution in the recycling circuit is maintained between minimum and maximum values by injecting into said circuit an agent for modifying said pH, such as a base, the quantity injected or the flow rate of the pH-modifying agent being adjusted directly according to the quantity or the flow rate of acid binder injected during the fiberizing process.

The invention also relates to the device for implementing the method.

The invention relates to the field of materials based on mineral fibers, especially mineral wool fibers of the glass or rock wool type. More particularly, the present invention relates to a method and a device for recycling the water recovered in a fiberizing and forming process when an acid binder, typically comprising a polyacid of the acrylic type, is used.

Most materials such as panels or rolls of insulation sold at the present time consist of mineral wool blanket or felt comprising mineral fibers, such as glass fibers coated with an organic binder.

The various steps and devices needed to manufacture insulation materials of this type are perfectly well known from the prior art. Typically, the formation of a glass fiber blanket comprises an internal centrifugation fiberizing process, illustrative examples of which have been described in patent applications EP 0 406 107 and EP 0 461 995 to which the reader may refer for details about the steps already known for implementing the present invention and without it being necessary here to describe them again in full.

More precisely, it is common practice in the formation of the aforementioned blankets or felts for the newly-formed fibers to be sprayed with an aqueous solution of a binder which after curing, binds the fibers together, as illustrated in the rest of the description, in conjunction with the appended figures. Until very recently, the binder used was most predominantly of the phenol-formaldehyde type (i.e. a phenol-formaldehyde binder). In such processes, the residual heat of the mineral fibers and the blown hot air created by suitable means through the fiber blanket, on a conveyor after the fiberizing, are sufficient to vaporize and eliminate most of the excess water contained in the initial binder composition. The mineral wool blanket, stripped of most of its moisture, is then sent into an enclosure or oven to complete the drying operation and to cure the binder. This curing is carried out, in a known manner, under conditions that ensure both the final mechanical integrity of the blanket obtained, owing to the bonding between the fibers, and the flexibility thereof, i.e. its capability of substantially recovering its initial shape and thickness after a step in which it is highly compressed, this being in particular necessary for packaging and transporting it.

To fulfill the above functions, phenol-formaldehyde resins, owing to their excellent cost performance ratio and their relative ease of preparation and use, have up till now been those most used. Current binder solutions also include for example urea and, before being sprayed onto the fibers, take the form of an aqueous solution or dispersion having a solids content of between 30 and 60% by weight.

However, such binder formulations may have the drawback of emitting, essentially during the mineral wool manufacturing process, very limited amounts of volatile organic compounds or VOCs, particularly formaldehyde. To anticipate situations in which the acceptable limit of such emissions will become lower and lower, new types of binders have more recently been developed.

Most particularly, solutions of binders incorporating into their composition polycarboxylic acids or precursors thereof, commonly referred to in the field as acrylic binders, have appeared as useful replacement products. Particularly, the rigidity and shape-recovery properties of glass fiber blankets obtained with certain acrylic binder compositions now seem to be comparable to those obtained with a phenol-formaldehyde binder. For example, but not limitingly, the acrylic binder solution, apart from the polyacid, also contains a polyalcohol and a catalyst for the reaction, for example a phosphorus-containing organic acid, such as for example illustrated by patent U.S. Pat. No. 5,661,213.

The main problem with the use of this type of resin lies in the acidity of the binder solution sprayed onto the fibers in the fiberizing chamber. Thus, depending on the type of resin used, a solution pH of generally less than 4, or even very often less than 3 or even 2.5, is needed for finally obtaining a blanket having the proper usage properties.

It follows that the water coming from the fiberizing process, in particular that recovered from the fiber-conveying belt after fiberizing, has a very high acidity.

It is common practice in the field to recycle and use some of this recovery water, and preferably all of it, for manufacturing the binder solution upstream of the fiberizing unit and/or for cleaning the constituent devices of the fiberizing line, as will be explained in detail later. Such a configuration has in particular the advantage of greatly minimizing the cost of the plant, by making it unnecessary to treat the waste water resulting from the process or by greatly minimizing the amounts to be treated. In a variant often used in the prior art, which is preferred but not obligatory according to the invention, the recycle loop for recycling the water resulting from the fiberizing process may incorporate the use of at least some or even all of the recovered water for scrubbing the various constituent elements of the apparatus that enables the fiber blanket to be obtained. More precisely, these elements are those that are in contact with the binder solution and the fibers during the fiberizing process, especially the walls of the fiberizing chamber or hood, the fiber-conveying means after fiberizing, or else the venting means used for removing the excess water from the fibrous blanket. The recycle loop may also incorporate the use of at least some or even all of the recovered water for scrubbing and/or cooling the fumes and gases generated in the process, such as the gases generated from the binder curing oven or the fiberizing unit.

It will therefore be understood that, within the context of such recycling, the high acidity of the recovered water is a real problem since the equipment, such as the recycling lines, are subject to very strong corrosion. Consequently, their lifetime becomes significantly reduced.

One possible and obvious solution consists in using pipes made of a metal known for its corrosion resistance properties, such as stainless steel. However, such a solution incurs a substantial cost overhead and does not guarantee sufficient effectiveness over time, while still posing problems for the maintenance operators having to handle the liquids present in the circuit, especially if this has to be purged or cleaned.

Other solutions have been proposed for extending the lifetime of said lines.

According to a first approach, patent application US 2003/221457 proposes measuring the pH of the recovered water within a collector device placed in the center of the recycling circuit. The pH is measured by means of a pH probe continuously delivering data to a processor, which is itself connected to a reservoir of a base solution. According to the operating principle of this method, if the probe detects that the pH of the recovered water is below a pH of 8, the processor triggers the injection of base into the circuit.

According to another approach, described in patent application US 2006/198954, which is a variant of the previous one, a corrosion detection device, placed in the recycling line before or after the water collection device or in the latter, is used to maintain the level of corrosion at an acceptable value for the metal of which the walls of the recycling circuit are made.

U.S. Pat. No. 7,153,437 also describes a very similar solution to that of patent application US 2003/221457, with the difference that the pH setting given by the control unit that releases the base solution into the recycling line is this time between 6 and 8.

All the solutions proposed hitherto thus involve means for continuously controlling the acidity or the corrosivity of the aqueous solution circulating in the circuit for recycling the fiberizing process water. These control means involve the use and calibration of specific (pH, corrosion) probes that have a high unit cost and a lifetime that turns out to be rather short in use.

In the end, such a cost means that, over the duration, the gain brought about by such control is limited, especially compared with the use of stainless steel pipes.

Unexpectedly, although the teaching of the prior art would direct an expert to solutions involving fine continuous regulation of the acidity and/or the corrosivity of the water circulating in the recycling circuit, the Applicant has found that less sophisticated and in particular less expensive solutions enable the level of corrosion of the pipes constituting said recycling circuit to be controlled quite acceptably.

More particularly, and according to a first aspect, the experiments carried out by the Applicant show that the pH within the circuit may vary widely around neutrality, i.e. typically greater than 6, or even greater than 6.5, and less than 9, or even less than 8.5, without major corrosion problems being observed in the duration on the pipes.

According to another aspect, the Applicant has found that the use of expensive probes for measuring the pH or the level of corrosion, and also the associated control means, is not necessarily worthwhile for properly controlling the level of corrosion of the circuit.

More precisely, and surprisingly, the Applicant has shown by experiment that it is possible for the level of acidity of the pH of the recovered water in the recycling circuit to be sufficiently controlled over a relatively long period of use of the apparatus, on the basis of a simple relationship between the flow rate of acid binder injected into the fiberizing product and the flow rate of the base solution injected into the recycle water.

In its most general aspect, the subject of the present invention is a method of controlling the level of corrosivity of an aqueous solution recovered during a process for producing a blanket of mineral fibers, comprising in particular the fiberizing and the coating of said fibers with a binder comprising a polyacid typically of the acrylic type, said aqueous solution being at least partly recycled into a zone in which said binder is prepared and/or a scrubbing zone of the production plant, the method being characterized in that the pH of the solution in the recycling circuit is maintained between minimum and maximum values by injecting into said circuit an agent for modifying said pH, such as a base, the flow rate of the pH-modifying agent being adjusted directly according to the flow rate of acid binder injected during the fiberizing process.

Most simply, the flow rate of the pH-modifying agent in the recycling circuit may be directly proportional to the flow rate of acid binder injected in the fiberizing process.

According to the invention, the ratio R may be adjusted at regular intervals by a spot measurement of the pH of the water recovered in the recycling circuit.

Typically, the value of the pH is between about 6 and about 9.

According to the invention, the fiberizing process water is at least partly recovered on the fiber-conveying belt after said fiberizing.

The fiberizing process water may also be at least partly recovered in the mineral fiber crosslinking oven.

Advantageously, the recovered water is at least partly used to scrub at least one of the constituent elements of the device for obtaining the fiber blanket, especially the walls of the fiberizing chamber or hood, the fiber-conveying means, the venting means used for removing the excess water from the fiber blanket, or even the fiber crosslinking enclosure.

For example, the pH-modifying agent is chosen from alkaline bases of the alkali or alkaline-earth metal hydroxide or carbonate type.

In general, the polyacid is chosen from polycarboxylic acids of the family of acrylic, methacrylic, crotonic, isocrotonic, maleic and cinnamic acids.

Furthermore, the invention relates to a plant for producing a fiber blanket, comprising a fiberizing unit incorporating means for spraying a solution of a binder comprising a polyacid, typically of the acrylic type, onto the newly-formed fibers, means for collecting the binder-impregnated fibers and for conveying them to a crosslinking enclosure and suction means for sucking up an aqueous solution comprising the excess binder and water from the fiber blanket collected on the conveying means, said suction means being in fluid communication with a recycle loop for recycling said aqueous solution into a station for preparing the binder solution supplying the spray means and/or into means for scrubbing the plant, said plant being characterized in that it further includes means for injecting and regulating a controlled amount of a pH-modifying agent such as a base and in that said regulating means are slaved to control means calibrated according to the amount of polyacid injected into the fiberizing unit.

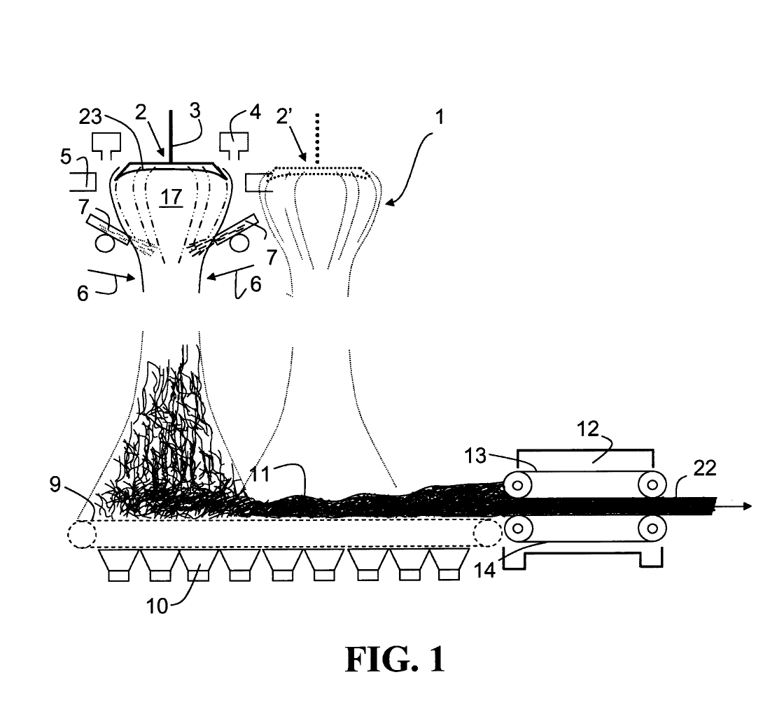

Other details, features or advantages are illustrated by the following embodiments of the invention described with reference to the appended FIGS. 1 to 4:

FIG. 1 illustrates in detail a fiberizing device for a glass wool blanket, known per se and incorporating the use of an acid binder;

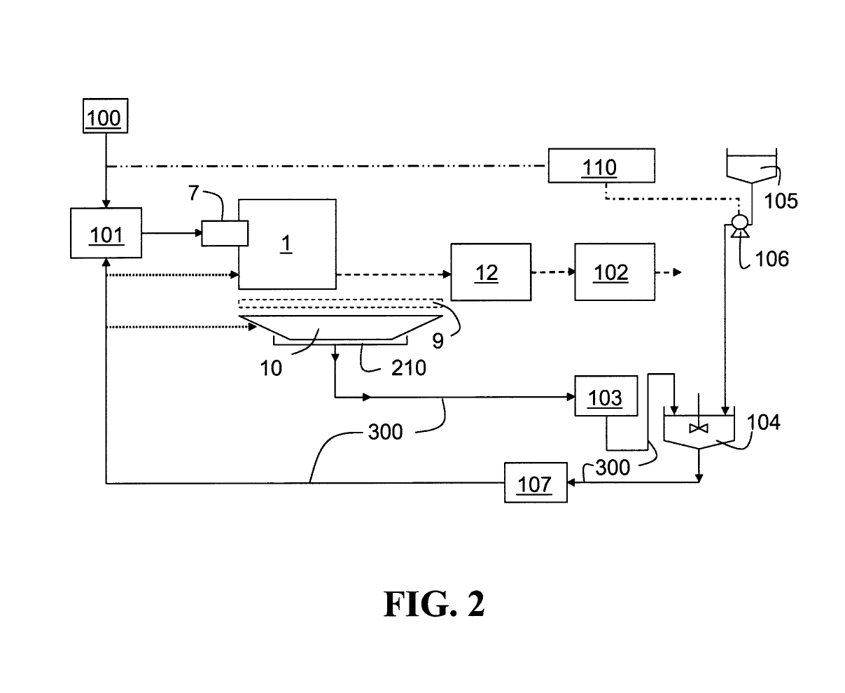

FIG. 2 is a synoptic view of a production line according to the invention for manufacturing insulating panels based on glass wool, incorporating a recycling circuit for recycling the excess water resulting from the fiberizing device;

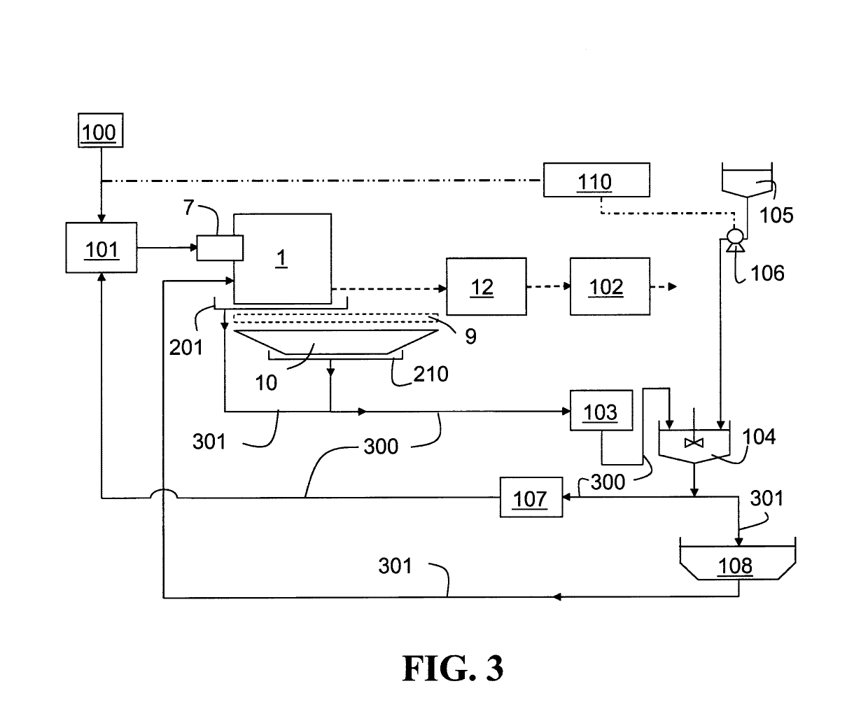

FIG. 3 differs from FIG. 2 in that the recycling circuit further includes means for scrubbing the walls of the fiberizing hood; and

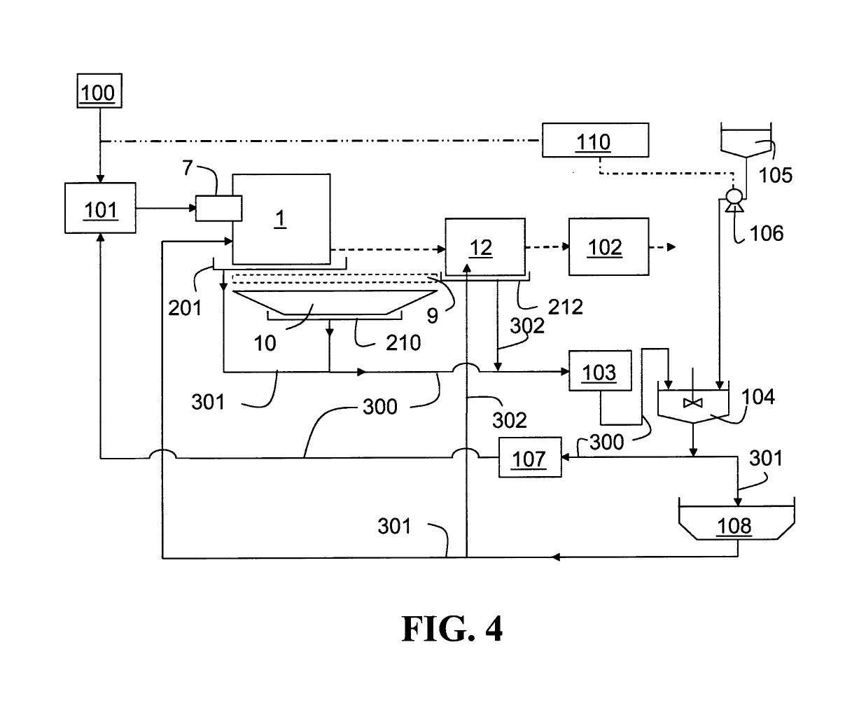

FIG. 4 differs from FIG. 3 in that the recycling circuit further includes means for scrubbing the fumes emulating from the crosslinking oven.

FIG. 1 shows a device conventionally used for fiberizing glass wool, for example in accordance with the internal centrifugation fiberizing process developed by the Applicant, illustrative examples of which are described in patent applications EP 0 406 107 and EP 0 461 995. The actual fiberizing unit 1 is well known. The fiberizing unit comprises a hood (not shown in FIG. 1) surmounted by one or more spinners 2, 2′. Each spinner comprises a basket (not shown in FIG. 1) for recovering the molten glass and a dish-shaped part 23, the peripheral wall of which is provided with a number of holes. In operation, the molten glass, supplied as a stream 3 from a melting furnace (not shown) and firstly collected in the basket of the spinner, escapes via the holes in the dish 23 in the form of a multitude of rotated filaments. The spinner 2 is also surrounded by an annular burner 4 that creates around the periphery of the wall of the spinner, a high-velocity gas stream at a temperature high enough to attenuate the glass filaments into fibers, which form a torus 17. According to this process, fiberization is complete and 100% of the fibers produced can be used. The process furthermore ensures that the fibers are long and flexible.

The torus 17 is enclosed by a gaseous stream of air injected under pressure, shown schematically by the arrows 6. The torus 17 is surrounded by a device for spraying a binder containing an aqueous solution of a polyacid typically of the acrylic type, only two elements 7 of which are shown in FIG. 1. For example, possible aqueous binder solutions are those described in the publications US 2003/221457, US 2006/198954 and U.S. Pat. No. 7,153,437.

The bottom of the fiberizing hood is formed by a fiber collection device comprising a conveyor 9 incorporating an endless belt permeable to gases and to water, below which there are suction boxes 10 for sucking out and separating the fluids contained in the newly-formed blanket that result from the fiberizing process described above. The suction boxes 10 are for example connected to a fan (not shown in FIG. 1) enabling a vacuum to be maintained in them. The fluids are gases such as air and fumes, and also an excess aqueous phase incorporating the excess binder and fines. A blanket 11 of glass wool fibers intimately mixed with the binder is formed on the belt of the conveyor 9. The blanket 11 is conducted by the conveyor to a crosslinking oven or enclosure 12. This enclosure 12 usually consists of a closed chamber comprising a series of boxes or compartments supplied by burners with hot air circulated by fans (not shown in FIG. 1). Passing through the enclosure are for example two complementary conveyors 13, 14 for transport and thickness-setting purposes.

While allowing the hot gases to pass through them, enabling the binder to be rapidly cured, the conveyors 13, 14 compress the blanket so as to give it the desired thickness. To give an example, for a rolled felt, this thickness is typically between 10 and 150 mm, the density of the glass wool layer being for example between 10 and 100 kg/m³. The curing in the enclosure 12 causes the residual water to be evaporated in the form of fumes, which are recovered and treated at the outlet of the enclosure, and causes the binder between the fibers of the blanket to crosslink.

FIG. 1 shows a system for collecting and conveying the fibers that comprises an endless belt system. However, the present process may also be implemented by a system comprising several corresponding collection zones each having one or more fiberizing machines and each collection zone consisting for example of a pair of counter-rotating drums according to the principles illustrated by patent EP 0 406 107.

The diagram of FIG. 2 is a schematic and synoptic illustration incorporating the fiberizing device according to FIG. 1 with one embodiment of a line according to the invention for producing insulating panels based on glass wool, and incorporating a recycling circuit for recycling the excess water coming from the fiberizing device described above.

In FIGS. 1 to 4, identical elements or those of the same nature bear identical reference numbers. As described in relation to FIG. 1, the fiberizing device 1 is used to obtain, on the endless belt conveyor 9, a blanket of fibers impregnated with the acrylic solution, which blanket is then shaped and cured in the enclosure 12 before being subjected to other well-known operations such as edge trimming, longitudinal and/or transverse slitting, surface treatment, etc., within various devices 102 employing known technology. The dotted arrows indicate the direction of advance of the fiber blanket through the plant.

As mentioned above, the endless belt of the conveyor 9 is permeable to fluids, such as the fumes and excess water, which are sucked out by the boxes 10. Means 210 for collecting the aqueous phase, incorporating the excess binder and fines, are placed beneath the suction means 10. According to the invention, these means 210 are in fluid communication with a recycling circuit 300 for recycling the water into the fiberizing device 1. In FIG. 2, the pipes of the recycling circuit 300 are shown by solid lines, the arrows indicating the direction of flow of the aqueous solution in the pipes. The water recovered by the collection means 210 is then transferred to a filtration device 103, designed to remove the particles and fibers having a diameter greater than 500 microns. On leaving the device 103, the aqueous phase is transferred to a stirred tank 104.

The tank 104 may be in fluid communication with a reservoir 105 containing a base solution, for example such as that described in the publications US 2003/221457, US 2006/198954 and U.S. Pat. No. 7,153,437. The base solution is injected into the tank 104 by a control means 106, such as a pump and/or a valve. According to the invention, the amount of base injected is used to maintain the pH within a range of values for which the metal of the pipes of the circuit 300 is preserved. According to the invention, it has been found that the pH range can vary by several pH units around neutrality without the equipment being substantially affected over time. The solution finally obtained after injecting the base is then at least partly recycled into a station 101 for preparing the aqueous acrylic binder solution, another part of the solution optionally being used for scrubbing the boxes 10 or the movable walls of the fiberizing hood. Preferably, a second filtration device 107, placed downstream of the tank 104, is used to remove the particles and fibers having a diameter greater than 50 microns.

The station 101 for preparing the aqueous binder solution is fed with a polyacid resin stored in a container 100, usually in the form of an already prediluted aqueous solution, typically containing about 50% solids by weight. Examples of such compositions are for example described in the publications US 2003/221457, US 2006/198954 and U.S. Pat. No. 7,153,437.

The aqueous binder solution, injected by the spray devices 7 (cf. FIG. 1), is prepared in the station 101 from the solution delivered by the container 100, the titre of said solution being well known. This initial solution is diluted in the station 101 in the proportions necessary for implementing the fiberizing process. The dilution is carried out according to the invention at least partly using the aqueous solution coming from the recycling circuit 300. Of course, although not shown in FIG. 2, means for topping up with clean water are also provided, either in the station 101 or else on one element of the recycling circuit 300 or in the tank 104.

In general, acrylic-based sizing compositions are characterized by a larger amount of water than solutions of the phenol-formaldehyde type, the percentage solids content by weight of the solid binder in the sizing composition generally not exceeding 20% by weight, which explains why the amounts of water circulating in the circuit 300 are relatively large and why such recycling is economically and environmentally important.

According to the invention, the flow rate, or the amount injected, of acid binder contained in the container 100 is regulated by a measurement and control device 110. The means 106 for regulating the flow rate of the base is slaved to the device 110. According to the invention, the device 110 controls, according to the measurement of the resin/acid binder flow rate and by the use of the means 106, the injection into the tank 104 of a defined amount of base according to a simple relationship between the flow rate of the acid binder and the flow rate of the base solution. According to the invention, throughout the duration of the fiberizing process, and especially when the flow rate of injected acid binder has to be modified for the requirements of said process, the injected base flow rate is directly adjusted according to this new value without it being necessary to involve probes or sensors, as described in the prior art. Thus, depending only on the measurement of the respective flow rates of the binder and the pH-modifying agent, it is possible according to the invention to preserve the recycling circuit throughout the duration of the fiberizing process. In particular, according to the invention, any variation in the acid binder flow rate during the fiberizing process results in a modification/adjustment of the flow rate of the pH-modifying agent, enabling the pH in the recycling circuit to be controlled simply, suredly and inexpensively. The device 110 comprises for example a sensor, such as a flowmeter together with a logic device and an actuator, for example of the control valve or variator type. The latter two systems set the controlled flow rate of the base solution. Of course, the device 110 is not limited to this embodiment alone, it being possible to use any equivalent or alternative device or system without departing from the scope of the present invention.

Without the invention being limited thereby, it has been found, surprisingly, by the Applicant, according to the abovementioned principles, that a simple relationship, for example a proportionality in the form of a ratio R between the flow rate of the acid binder and the flow rate of the base solution is sufficient to maintain the acidity of the water circulating in the circuit at levels acceptable for preserving the circuit 300. The ratio R may be defined by the chemical characteristics of the constituents of the sizing composition (number of acid functional groups provided by the constituents of the size and the associated acidity constants pK_{A}) and by the process (dilution water injection) and plant (efficiency) parameters and according to the type of base used as neutralizing agent (basicity constant pK_{B}).

According to one advantageous embodiment of the invention, the ratio R of the acid binder flow rate to the base solution flow rate can be periodically adjusted or reset by point measurements of the pH of the aqueous solution at one or more points in the recycling circuit. The trials carried out by the Applicant have shown that pH measurements carried out on the line 300 separated by several minutes, or even several tens of minutes and sometimes even several hours, have however proved to be sufficient for detecting and remedying any drift and in the end eliminating any risk of the pipes corroding. This setting of the pH does not require excessive precision and may be carried out simply by an operator immersing a simple pH paper in a liquid aliquot taken at any point in the recycling circuit 300. Thus, it has been checked that the pH of the recycle water can freely fluctuate over a wide range during a production run, namely from about 6 to about 9, without the equipment being appreciably degraded.

Of course, and in particular if a smaller variation in the pH range in the circuit 300 is desired, more complex relationships than a simple proportionality may be used without departing from the scope of the invention. In particular, according to one possible embodiment, the relationship between the acid binder flow rate and the base solution flow rate may be expressed in the form of pre-established charts, for example those characteristic of the actual plant.

FIG. 3 illustrates an alternative embodiment in which the recycle loop 300 for recycling the water resulting from the fiberizing process incorporates the use of some of the water recovered for scrubbing the walls of the fiberizing chamber or hood. Additional collection means 201 allow the water for scrubbing the walls of the fiberizing hood to be recovered. These means 201 are connected to the recycling circuit 300 for recycling the water from the suction boxes 10 via additional pipes 301. The water recovered from the collection means 201 and 210 are thus mixed in the circuit 300. Without departing from the scope of the invention, some of the recovered water in the circuit 300 may also come from a unit for scrubbing the gases emanating from the fiberizing unit 1. According to the principles already described in relation to FIG. 2, the recovered water is filtered in the device 103 and neutralized in the tank 104. Some of the treated water is then sent into the station 101, as described above in relation to FIG. 2, while another part is collected in a well 108 before being reused for scrubbing the walls of the fiberizing hood 1.

FIG. 4 illustrates an embodiment identical to the previous one, but in which the loop 300 for recycling the water resulting from the fiberizing process incorporates the use of some of the water recovered both for scrubbing the walls of the fiberizing chamber or hood and for removing the binder and fiber residues in the oven 12. For this purpose, means 212 for recovering the water used to scrub the oven 12 and/or the fumes resulting therefrom are additionally provided together with additional pipes 302, making it possible, on the one hand, to inject the recovered water into the loop 300 and, on the other hand, to reinject some of the water treated in the tank 104 into the oven 12 or the system for scrubbing the fumes emanating therefrom, as illustrated in FIG. 4.

In contrast to the prior teaching, the trials carried out by the Applicant on plants such as those shown diagrammatically in the abovementioned FIGS. 1 to 4, demonstrate that it is in no way essential to use control devices that continuously control the probes measuring the pH or the level of corrosion in order to prevent rapid degradation of the pipes of the circuit by corrosion. Most particularly, the abovementioned solutions or those described in the claims that follow, which solutions are simpler and less expensive than those described previously, enable just as satisfactory a result to be achieved.

To give an example, it has been possible to show, by measurement, on a plant of the type shown diagrammatically in FIG. 4, that the pH of the water recycling circuit of a process incorporating the use of an acrylic binder can be maintained for several hours in a pH range between 6 and 9 without the need for external intervention or for any modification to the initial operating conditions of the device 110. In this example, a setpoint value of the ratio of the amount of sodium hydroxide solution from the reservoir 105 and then injected into the circuit (i.e. into the tank 106) to the amount of binder solution injected into the process at the spray device 7 was input into the device 110.

The conditions of the experiment were the following:
volume ratio R of the amount of pure sodium hydroxide injected to the amount of resin injected (excluding dilution): R=0.1;
dilution of the resin to 5% by volume;
dilution of the sodium hydroxide to 50% by volume;
approximately constant flow rate of binder output by the spray device: 200 l/h; and
constant flow rate of sodium hydroxide output by the pump 106 into the tank 104: 2 l/h.

1. A method of controlling the level of corrosivity of an aqueous solution recovered during a process for producing a blanket of mineral fibers, in which the fiberizing and the coating of said fibers with a binder comprises a polyacid, said aqueous solution being at least partly recycled into a zone in which said binder is prepared and/or a scrubbing zone of the production plant, said method comprising maintaining the pH of the solution in the recycling circuit between minimum and maximum values by injecting into said circuit an agent for modifying said pH, the flow rate of the pH-modifying agent being adjusted directly according to the flow rate of acid binder injected during the fiberizing process.

2. The control method as claimed in claim 1, in which the flow rate of the pH-modifying agent in the recycling circuit is directly proportional to the flow rate of acid binder injected in the fiberizing process.

3. The control method as claimed in claim 2, in which the ratio R is adjusted at regular intervals by a spot measurement of the pH of the water recovered in the recycling circuit.

4. The control method as claimed in claim 1, in which the value of the pH is between about 6 and about 9.

5. The control method as claimed in claim 1, in which the fiberizing process water is at least partly recovered on the fiber-conveying belt after said fiberizing.

6. The control method as claimed in claim 1, in which the fiberizing process water is at least partly recovered in the mineral fiber crosslinking oven.

7. The control method as claimed in claim 1, in which the recovered water is at least partly used to scrub at least one of the constituent elements of the device for obtaining the fiber blanket.

8. The control method as claimed in claim 1, in which the pH-modifying agent is chosen from alkaline bases of the alkali or alkaline-earth metal hydroxide or carbonate type.

9. The control method as claimed in claim 1, in which the polyacid is chosen from polycarboxylic acids of the family of acrylic, methacrylic, crotonic, isocrotonic, maleic and cinnamic acids.

10. A plant for producing a fiber blanket, comprising a fiberizing unit incorporating means for spraying a solution of a binder comprising a polyacid, onto the newly-formed fibers, means for collecting the binder-impregnated fibers and for conveying them to a crosslinking enclosure and suction means for sucking up an aqueous solution comprising the excess binder and water from the fiber blanket collected on the conveying means, said suction means being in fluid communication with a recycle loop for recycling said aqueous solution into a station for preparing the binder solution supplying the spray means and/or into means for scrubbing the plant, said plant further including means for injecting and regulating a controlled amount of a pH-modifying agent and in that said regulating means are slaved to control means calibrated according to the amount of polyacid injected into the fiberizing unit.
